(19) United States
(12) Patent Application Publication
(10) Pub. No.: US 2005/0204038 A1
(43) Pub. Date: Sep. 15, 2005

(54) Method and system for distributing data within a network

(76) Inventors: Alexander Medvinsky, San Diego, CA (US); Geetha Mangalore, San Diego, CA (US); Petr Peterka, San Diego, CA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/798,050

(22) Filed: Mar. 11, 2004

(51) Int. Cl. G06F 15/173; G06F 17/60

(52) U.S. Cl. 709/225; 709/224

(57) ABSTRACT

A method (300) for distributing data (25), within a network (11), between a source consumer (50) and a destination consumer (250). The data (25) originates from, and is protected by predetermined intellectual property rights of, a third party (20). The method (300) includes: specifying (302) a first access condition associated with the data, the access condition based on the predetermined intellectual property rights; based on a request requesting transfer of the data from the source consumer to the destination consumer, and based on a service ticket issued by an authority associated with the source consumer, arranging (304) for authentication of the destination consumer; and after authentication of the destination consumer, based on a second access condition issued by an authority associated with the source consumer, arranging (306) for transfer of the data, via the network in a peer-to-peer manner, from the source consumer to the destination consumer. Use (308) of the data is restricted in a manner specified by access conditions.

### BACKGROUND OF THE INVENTION

1. Field of the Invention

Aspects of this invention relate generally to data distribution, and more particularly to a method and apparatus for secure and legal peer-to-peer distribution of data within a network.

2. Description of Related Art

Digital data is delivered to consumers by public and private content providers such as, among others, Internet broadcasters and service providers, studios, cable and satellite operators, advertisers, and television networks and stations. At least as many public and private networks facilitate data delivery, such as the Internet, fiber-optic networks, coaxial cable networks, hybrid networks, satellite networks, cellular networks, television networks, radio networks, and copper wire networks.

Consumers capture content-which is often protected by the intellectual property rights of the content provider or others—using an ever-increasing variety of devices, such as home- or office-based personal computer (“PC”) systems, receiving, recording, or playback devices like VCRs, TiVO®, stereo systems and personal computer/television (PC/TV) devices (which may stand alone, or be included in other devices, such as set-top boxes), and other types of wired or wireless devices, such as personal digital assistants, radio frequency communication devices, and other consumer appliances. In addition, the consumer appliances capturing content often include network support equipment and/or software, such as home gateways, modems and streaming media players.

Consumers may desire to share captured content with other consumers in a variety of manners—by streaming, moving, or copying, for example. Content and/or service providers may also be interested in delivering sharable content, such as content containing advertisements, to consumers, but are also concerned with reducing the likelihood of illegal sharing of content protected by enforceable intellectual property rights.

An information service such as the World Wide Web uses standard protocols to allow computer users with a browser application to transfer data to and from computer networks such as the Internet. The Internet is generally an insecure network, however, and data, such as delivered content, protected by the intellectual property rights of third parties may be shared illegally between consumers using the Internet. Large, public peer-to-peer networks that facilitate data sharing between consumers (for example, KaZaA) do not address the problem of protection of the intellectual property rights of third parties in the shared data, and public key encryption systems are not sufficiently scalable for efficient use in such networks.

Client-server architectures, such as those in which computer application programs are configured to cause clients, such as consumer appliances, to request services from server-based service providers in a network such as the Internet, are often equipped to provide additional and scalable privacy or security for data shared between clients and servers. For example, U.S. Patent Application Publication No. 2003/0093694, incorporated by reference in its entirety for all purposes, as if set forth in full herein, describes an “Internet Protocol Rights Management” system that uses client-server techniques and an authenticated key management protocol called ESBroker, which is based on the Kerberos Network Authentication Service, to implement a service that allows content providers to securely deliver data in a variety of manners to consumers via a network such as the Internet. A description of the Kerberos Network Authentication Service, which allows a client and server to authenticate themselves to each other across an insecure network connection, and which is based on key and ticket exchanges between clients and servers, is found in an Internet Engineering Task Force (“IETF”) published draft document entitled “Draft-IETF-KRB-WG-Kerberos-Clarifications-04.txt”, by Neuman et al, Mar. 2, 2003. Client-server architectures or applications, however, are not generally equipped to authenticate or control peer-to-peer data sharing.

There are, therefore, needs for scalable methods, apparatuses, computer programs, and systems, which utilize authenticated key management protocols to securely distribute data between consumers in a peer-to-peer manner in a network, when the data originates from, and is protected by the intellectual property rights of, third parties.

### SUMMARY

According to one aspect of the present invention, a method for distributing data, within a network such as the Internet, between a source consumer and a destination consumer, the data originating from, and protected by predetermined intellectual property rights of, a third party, includes: specifying a first access condition associated with the data, the access condition based on the predetermined intellectual property rights; based on a request requesting transfer of the data from the source consumer to the destination consumer, and based on a service ticket issued by an authority associated with the source consumer, arranging for authentication of the destination consumer; and after authentication of the destination consumer, based on a second access condition issued by an authority associated with the source consumer, arranging for transfer of the data, via the computer network in a peer-to-peer manner, from the source consumer to the destination consumer. Use of the data by the destination consumer is restricted in a manner specified by the first and second access conditions. A computer-readable medium may be encoded with a computer program which, when loaded into a processor, implements the method.

The first access condition may be based on consumer characteristics of the destination consumer (which may be a device such as a set-top box), such as destination consumer name, or destination consumer device identity, and/or may be based on a content license, located at the source consumer, from the provider of the data. The method may further include authenticating the destination consumer, and based on the first and second access conditions, transferring (via streaming, moving or copying, for example) the data in a peer-to-peer manner from the source consumer to the destination consumer. The data may be encrypted prior to transfer, and authenticated after transfer. The destination consumer may create a content license, and the use of the data may be restricted in a manner specified in the content license.

The service ticket may be obtained with a ticket granting server request/reply exchange between the destination consumer and a key distribution center associated with the source consumer, and authenticated using a ticket granting ticket encrypted with a cross-realm key. Alternatively, the destination consumer is authenticated with a digital authentication certificate. Authentication of the destination consumer using the cross-realm key includes establishing security associations between the key distribution center associated with the source consumer, and a key distribution center associated with the destination consumer, using the shared cross-realm key.

According to another aspect of the present invention, a system for distributing data, within a network, between a source consumer responsive to a first key distribution center and a destination consumer responsive to a second key distribution center, is provided. The data originates from, and is protected by predetermined intellectual property rights of, a third party. The system includes a network communications interface for receiving a request for transfer of the data from the source consumer to the destination consumer, and for transferring the data from the source consumer to the destination consumer, via the network, in a peer-to-peer manner in response to the request. The system also includes an information processing system in communication with the network communications interface, for processing the request received by the network communications interface, and, based on the request, performing a method including: arranging for authentication of the destination consumer based on a service ticket issued by the first key distribution center; arranging for determining whether the destination consumer is authorized, in a manner specified by a first access condition based on the predetermined intellectual property rights of the third party, to receive the data from the source consumer; and based on a second access condition returned by the source consumer, arranging for transfer, via the source network communications interface, of the data from the source consumer to the destination consumer. Use of the data by the destination consumer is restricted in a manner specified by the first and second access conditions.

The network communications interface may be associated with a gateway device of the source or destination consumer, or with a server accessible to the source consumer via the network, and the information processing system may be a processor responsive to a computer-readable storage medium and to a computer program, which, when loaded into the processor, is operative to perform the method. The processor may be associated with the gateway device, or with the server.

### BRIEF DESCRIPTION OF THE DRAWINGS

FIG. 1 is a diagram illustrating an architecture for securing interfaces between clients and servers exchanging data within a network.

FIG. 2 is a diagram illustrating an architecture for securing interfaces between peer devices exchanging data within a network, in accordance with aspects of the present invention.

FIG. 3 is a flowchart of a method for securely distributing data within a network in a peer-to-peer manner, in accordance with an aspect of the present invention.

### DETAILED DESCRIPTION

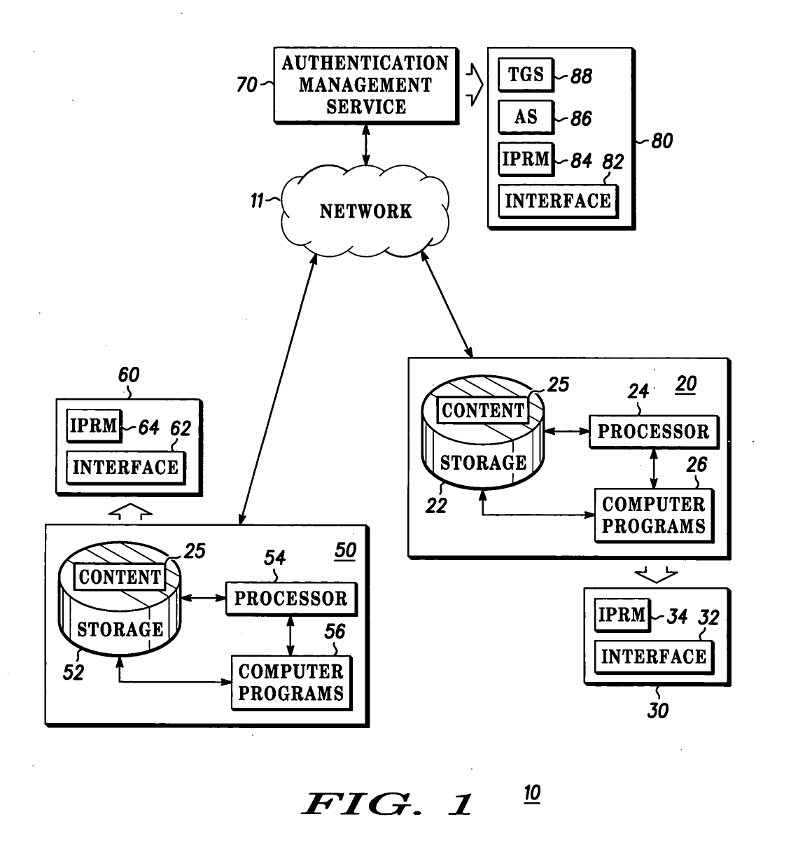

Turning now to the drawings, wherein like numerals designate like components, FIG. 1 illustrates a block diagram of an architecture 10 for securing interfaces, and for delivering content, between a service provider 20 and a consumer 50 via network 11, using authentication management service 70 to provide security, privacy and management of intellectual property rights associated with the content.

For exemplary purposes, network 11 is the Internet, service provider 20 is a network server, consumer 50 is a single-user or multiple-user multi-programming processing system, such as a gateway, and authentication management service 70 is a key distribution center using the ESBroker key management protocol, as described in U.S. Patent Application Publication No. 2003/0093694, which is hereby incorporated by reference in its entirety for all purposes, as if set forth in full herein.

It will be understood, however, that network 11, and connections throughout network 11, may encompass any type or size of existing or future, public or private, wired or wireless infrastructure or technology, including but not limited to a fiber-optic network, a coaxial cable network, a hybrid network, a satellite network, cellular network, a broadcast network, a copper wire network, or any combination thereof. Network 11 may also include layers of other computers or networks, including but not limited to local area networks and wide area networks.

Service provider 20, which may be one or more servers, or may be a different type of processing device altogether, may be an Internet broadcaster or service provider, a studio, a television network or station, a publisher, a cable operator, a satellite operator, a communications provider, or any suitable source of content 25 (discussed further below). As shown, service provider 20 is a server having a well-known internal arrangement including items such as a computer-readable storage medium 22, a processor 24, and computer programs 26. Server 20 may further include other well-known elements (not shown), configured in well-known manners using well-known techniques, such as: physical memory; additional storage devices; disk controllers; network adapters or interfaces; or human-device interfaces.

Computer-readable storage medium 22 stores, among other things, content 25. Content 25 represents any data, such as video, audio, or publication material, which is protected by the intellectual property rights of service provider 20 or other third parties, and which may be transferred to consumer 50, via authentication management service 70.

Processor 24 is responsive to computer-readable storage medium 22 and computer programs 26. Computer programs 26 are generally organized into functional components. Block 30 illustrates certain aspects of the functional arrangements of computer programs 26 that pertain to the delivery of content 25 from service provider 20 to consumer 50 via network 11, using authentication management service 70.

Network/communication interface function 32, which may support, for example, a modem or other network connection support device(s) or program(s), is responsive to, and responsible for, mechanics of communication between Internet Protocol Rights Management (“IPRM”) Application 34 (discussed further below), IPRM Application 64 (also discussed further below, in connection with consumer 50), and IPRM Application 84 (also discussed further below, in connection with authentication management service 70) via network 11, and may be selected or implemented by one skilled in the art.

IPRM application 34 represents the client component, or agent, of a computer program, which, when executed, is capable of implementing one or more aspects of the process of delivering content 25 from service provider 20 to consumer 50 via network 11 using authentication management service 70. IPRM application 34 may support, for example, composition, transmission, encryption, encoding, and compression of outbound communications and reception, decompression, decoding, decryption and presentation of inbound communications for a given type of media.

As shown, IPRM application 34 is a computer program stored in computer-readable memory 22, but may be hardware, software, firmware or any combination thereof. In addition, IPRM application 34 may operate as a client or a server component, as more fully described in U.S. Patent Application Publication No. 2003/0093694.

IPRM application 34 is preferably adapted to respond to IPRM application 84 (discussed further below), and IPRM application 64 (also discussed further below) via network/communication interface function 32. Both client and server components and functions of IPRM application 34 may be implemented according to well-known software engineering practices for component-based software development.

Consumer 50 is depicted as a gateway, but may be any other type of consumer appliance adapted to receive content 25 from service provider 20. Gateway 50 may be a home gateway. Suitable gateways 50 are commercially available from Motorola, including the Motorola MS-1000™, and the Motorola SBG-1000™.

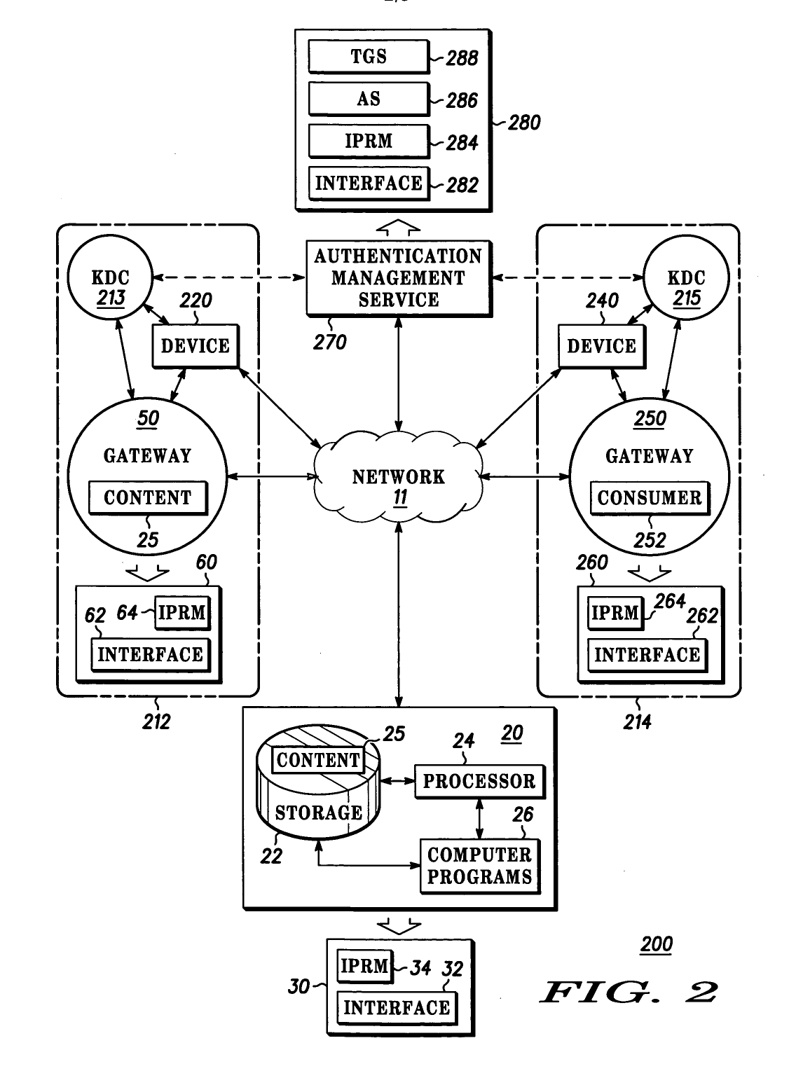

Internal arrangements, architectures and principles of operation of gateway 50 are well-known. Gateway 50 may include items such as a computer-readable storage medium 52, a processor 54, and computer programs 56, operating to implement an interface between managed devices (for example, devices 220 and 240 shown in FIG. 2 and discussed further below) and network 11. Other items (not shown) may include a modem or other network adapter or interface, such as a router, operational and/or in communication with other elements of gateway 50 in accordance with well-known methods and techniques. It will be understood, however, that gateway 50 may be implemented in various manners—for example, software such as a daemon that emulates an Internet connection service operating at one site may communicate with hardware at a central location.

Storage medium 52 operates to store executable instructions, such as computer programs 56, which are performed by processor 54 to implement functions of gateway 50. Consumer characteristics, such as configuration data (not shown), which represents user—and system-defined configuration settings, such as communication settings, network settings, and the like, may also be stored on storage medium 52, for example in a database (not shown). Examples of consumer characteristics include device characteristics, such as realm name, the fully qualified domain name (“FQDN”) or IP address of the gateway and the gateway's principal name; and include configuration data, such as the FQDN or IP address of the content provider's key distribution center (discussed further below), the realm of the content provider, or the FQDN or IP address of the content servers from which the gateway can retrieve selected content.

Block 60 illustrates certain aspects of the functional arrangements of computer programs 56, that relate to the access by gateway to remote and/or central services or devices, such as service provider 20, authentication management service 70 and peer devices (such as another consumer gateway 250, shown in FIG. 2, and discussed further below).

Network/communication interface function 62, which may support, for example, a modem or other network connection support device(s) or program(s), is responsive to, and responsible for, mechanics of communication between IPRM Application 34, IPRM Application 64 (discussed further below), and IPRM Application 84 (also discussed further below, in connection with authentication management service 70) via network, 11, and may be selected or implemented by one skilled in the art.

IPRM application 64 represents the client component, or agent, of a computer program, which, when executed, is capable of implementing one or more aspects of the process of delivering content 25 from service provider 20 to consumer 50, and from consumer 50 to other consumers (such as another consumer gateway 250, shown in FIG. 2, and discussed further below), via network 11 using authentication management service 70. IPRM application 64 may support, for example, composition, transmission, encryption, encoding, and compression of outbound communications and reception, decompression, decoding, decryption and presentation of inbound communications for a given type of media.

As shown, IPRM application 64 is a computer program stored in computer-readable memory 52, but may be hardware, software, firmware or any combination thereof. In addition, IPRM application 64 may operate as a client or a server component, as more fully described in U.S. Patent Application Publication No. 2003/0093694.

IPRM application 64 is preferably adapted to respond to IPRM application 34 and IPRM application 84 (discussed further below), via network/communication interface function 62. Both client and server components and functions of IPRM application 64 may be implemented according to well-known software engineering practices for component-based software development.

Authentication management service 70 is preferably a ticket and key distribution center using the ESBroker key management protocol, as described in U.S. Patent Application Publication No. 2003/0093694, used to secure interfaces within network 11, such as the interface(s) between service provider 20 and consumer 50. More specifically, authentication management service 70 is capable of implementing one or more aspects of the process of protecting the intellectual property rights of service provider 20 in content 25 before, during, and subsequent to the transfer of content 25 to and between authorized consumers, such as consumer 50 and consumer 250 (shown in FIG. 2 and discussed further below), via network 11, using a blend of symmetric and asymmetric algorithms, which may be implemented in software, or may be provided in secure cryptographic hardware, or a combination thereof.

Authentication management service 70 may include one or more servers having the same basic internal components as service provider 20 (not shown, for example, computer-readable storage media, processors, and computer programs). Block 80 illustrates certain aspects of the functional arrangements of authentication management service 70.

Collectively, the functions of authentication management service 70 allow consumers and services to authenticate themselves to each other, through the use and issuance of authentication tokens. A ticket is an authentication token given to a client by authentication management service 70 via a message. Among other information, a ticket includes the name of the client, the name of a specific device and a session key (such as a symmetric encryption key). The client name and session key are encrypted with another key, called a service key, known only to authentication management service 70 and the server named in the ticket. A separate copy of the session key is sent to the client. Clients authenticate their own messages with tickets, by including in messages both a ticket and a checksum value (for example, based on the session key) in the ticket. When the device named in the ticket receives a message from the client, the device decrypts the ticket with the service key, verifies the client name, and obtains the session key. The session key is then subsequently used to verify the keyed checksum and thus authenticate the whole message. A ticket may include other information, such as a validity period, various flags, client authorization data (for example, subscribed services, geographical location, payment method, and any other data that may be relevant to user authorization).

Network/communication interface function 82, which may support, for example, a modem or other network connection support device(s) or program(s), is responsive to, and responsible for, mechanics of communication between IPRM Application 84, IPRM Application 34, and IPRM Application 64 via network 11, and may be selected or implemented by one skilled in the art.

IPRM application 84 represents a server component, or agent, of a computer program, which, when executed, coordinates the functions of authentication management service 70 described herein. As shown, IPRM application 84 is a computer program stored in a computer-readable memory, but may be hardware, software, firmware or any combination thereof. IPRM application 84 is responsible for processing key management messages (discussed further below).

IPRM application 84 is preferably adapted to respond to IPRM application 34 and IPRM application 64, via network/communication interface function 82. Functions of IPRM application 84 may be implemented according to well-known software engineering practices for component-based software development.

An authentication server (“AS”) function 86 represents one stage of a key distribution center implemented by authentication management service 70. AS function 86 issues tickets called ticket granting tickets (“TGTs”) to clients, such as service provider 20 or consumer 50, after verifying their credentials.

A ticket granting server (“TGS”) function 88 represents another stage of the key distribution center implemented by authentication management service 70. TGS function 88 provides a ticket called a service ticket (“ST”) to clients, which is presented by the clients to other devices, such as application servers (for example, service provider 20) or consumer gateways (for example, consumer gateway 50), when the clients request a service, such as delivery of content 25.

A key management function, which implements the ticket/key and messaging exchanges across all interfaces, is preferably effected by the ESBroker key management protocol via IPRM application 84. The basic messages in the ESBroker key management protocol applicable to aspects of the present invention are as follows:
(A) Authentication Server Request Message (AS_REQ): Message from a client to request a TGT from the AS function 86. The TGT is used to request tickets from other devices. The AS_REQ message includes the AS function 86's realm, the client's identity, the device's identity, a list of symmetric encryption algorithms that are supported by the client, and public key information that is necessary for key agreement (e.g., Elliptic Curve Diffie-Hellman parameters). A timestamp and a digital signature, and optionally a digital certificate may be provided for message integrity.
(B) Authentication Server Reply Message (AS_REP): In response to the AS_REQ message, AS_REP is a reply message to a client from AS function 86 that includes the TGT. The TGT has both a clear and an encrypted part. The KDC name and realm are provided in the clear part of the issued ticket. The encrypted part of the ticket, encrypted using AS function 86's secret key, includes the client's name, a session key, and any other private data. The message is signed by AS function 86 using the private key and signing algorithm that both correspond to the public key that was specified by the client in the AS_REQ.
(C) Ticket Granting Server Request Message (TGS_REQ): Message from a client to request an ST (that can be used in a KEY_REQ, discussed further below) from TGS function 88, presenting the TGT obtained from the AS_REP message. The session key from TGS function 88 is used for encryption and decryption of the TGS_REQ message, and for calculation of the checksum over the message.
(D) Ticket Granting Server Reply Message (TGS_REP): Reply message from TGS function 88 to a client that includes the ST, which the client presents to request a service from a particular server. The service name and the ticket validity period are provided in the clear inside the issued ticket. The encrypted part of the ticket contains the client's realm, the client's name, and the session key encrypted with a key shared by the service and TGS function 88, and any additional private client data, such as authorization data. The message is signed by the TGS function 88 with a keyed checksum using the TGT session key.
(E) Key Request Message (KEY_REQ): Message from a client to a server from which the client is requesting services, used to request keying material for a secure session with that server.
(F) Key Reply Message (KEY_REP): Reply message from the server to the client, which includes the requested keying material.
(G) Initialize Principal Request Message (INIT_PRINCIPAL_REQ): Message from a client to authentication management service 70 as part of initial client registration.
(H) Initialize Principal Reply Message (INIT_PRINCIPAL_REP): Reply message from authentication management service 70 to the client to acknowledge client registration.
(I) Client Enrollment Request Message (CLIENT_ENROLL_REQ): Message from a client to authentication management service 70, containing client public key and other attributes. This message applies only to clients that do not have digital certificates (for example, personal computers (“PCs”).
(J) Client Enrollment Reply Message (CLIENT_ENROLL REP): Reply message from authentication management service 70 that acknowledges registration of the client public key.

Messages generally include a common header, followed by the unique body of the message. The header may include a message type field, a protocol version number field, and a checksum field. It should be noted that similar functionality may be obtained using standard Kerberos messages (implemented together with the PKINIT draft referred to herein), corresponding to ESBroker messages in the following manner: KEY_REQ=AP-Request+KRB-SAFE; KEY_REP=AP-Reply+KRB-SAFE. KRB-SAFE would contain some additional information, such as information included in domain of interpretation (“DOI”) objects (discussed further below), and content licenses (also discussed further below).

Authorization management service 70 may include other functions (not shown), such as a provisioning center function, a database function, a search engine function, and a billing function, that may be may be selected or implemented by one skilled in the art. The provisioning center function may provide consumer authorization data, insertable by authentication management service 70 into tickets, such as the TGT.

In operation, the key management process between a client and authentication management service 70 is classified in two phases: (1) a generic phase in which a client is in contact with authentication management service 70 to obtain a ticket to access another device; and (2) a non-generic phase in which the client uses the ticket to form a KEY_REQ message to the other device. In the non-generic phase, a DOI object containing information that is specific to a particular use of the key management protocol over a particular interface being secured within network 11 is included in the KEY_REQ and/or KEY_REP message(s). The DOI object contains user selections, and other items, such as content licenses.

Content licenses specify permitted uses, and restrictions thereon (for example, geographical restrictions, device-type restrictions, copy or transfer restrictions), of content provided via the key management process(es) and/or secured interface(s). For example, content licenses are initially obtained by a consumer, such as consumer 50, from a content provider, such as service provider 20, via a KEY_REQ or KEY_REP message. Service provider 20 may generate one or more content licenses that set forth the rights consumer 50 has to use and/or share content 25 after it is transferred. The content license may be delivered from service provider 20 to other potential recipients of content 25 authenticated with a session key from a ticket. Content licenses may be arbitrarily complex and may be expressed in different formats, including type-length-value encoding or XML, among others, and may be applicable to one consumer, or to all consumers.

Regarding security over the interface between service provider 20 and consumer 50, during normal operation, authentication management service 70 operates to facilitate registration of consumer 50 and transfer of content 25 from service provider 20 to consumer 50, as provided in U.S. Patent Application Publication No. 2003/0093694.

To register with authentication management service 70, consumer 50 may access material, such as a web site or a CD-ROM, provided by authentication management service 70, and may receive IPRM Application 64 (which may include an ESBroker daemon) from authentication management service 70. Authentication management service 70 may establish user IDs for consumer 50, such as a principal name (a unique identifier for each registrant with authentication management service 70), and a host identifier (provided by the consumer during registration), which may be stored in a database (not shown) accessible by authentication management service 70, and other information, in accordance with well-known methods and techniques. Authentication management service 70 sometimes generates a provisioning ticket containing a key (a session key) for consumer 50, when the corresponding consumer device does not have its own digital certificate. The session key may be a symmetric key, used for authentication of messages between authentication management service 70 and consumer 50. If consumer 50 receives the provisioning ticket, the message will also include a session key seed (“SKS”), used by consumer 50 to reconstruct the provisioning key located within the provisioning ticket. The combination of the SKS with a unique host identifier using a one-way function generates the provisioning key. The SKS is specific to a particular host and can't be used anywhere else. The session key is used by authentication management service 70. Consumer 50 receives the provisioning ticket. A CLIENT_ENROLL_REQ message may be sent from consumer 50 to authentication management service 70, including a public key, symmetrically signed with the provisioning key derived from the SKS by consumer 50. The CLIENT_ENROLL_REQ is only used by consumers with a device such as a PC that does not already have an IPRM client digital certificate. Upon receiving the CLIENT_ENROLL_REQ message, authentication management service 70 finds consumer 50 in its local database to verify the request. If the request is valid, authentication management service 70 stores the public key, either locally or remotely. Authentication management service 70 sends a CLEINT_ENROLL_REP message acknowledging storage of the public key to consumer 50. Consumer is now enrolled and may access content, such as content 25, from various application servers, such as service provider 20.

After registration of consumer 50 (and service provider 20) with authentication management service 70, when consumer 50 desires to receive content (for example, content 25) from service provider 20, consumer 50 requests a TGT from AS function 86, by transmitting an AS_REQ message to authentication management service 70. The AS_REQ message includes consumer 50's identity, authentication management service 70's identity (more specifically the realm or administrative domain), and a nonce to tie it to a response. In response to the AS_REQ message, authentication management service 70 validates the request, verifies validity of consumer 50, and AS function 86 responds with an AS_REP message including the TGT to consumer 50 after verifying its credentials. If authorization fails, an error message may be forwarded to consumer 50. If authorization is successful, after receiving and storing the TGT, consumer 50 may start requesting content delivery from devices such as, among others, service provider 20. A TGS_REQ message containing the TGT is sent to authentication management service 70 requesting a ticket for service provider 20. In response to the TGS_REQ message, a TGS_REP message is sent by TGS function 88 to consumer 50, which includes an ST. Consumer 50 presents the ST to service provider 20, in a KEY_REQ message. After checking the content license, content 25 is delivered by service provider 20 to consumer 50 via the KEY_REP message. The content license may also be delivered to consumer 50. Content may be encrypted and decrypted using well-known methods and techniques. An example of a suitable encryption/decryption technique is set forth in U.S. Patent Publication No. 2003/0093694. Content may also be authenticated for the purpose of protecting a destination consumer—to ensure that the transferred content is genuine and not intentionally altered, either by the source consumer, or by another entity on the Internet that somehow intercepted and modified the transferred content.

Content 25 may be delivered in streaming or non-streaming form. Protocols such as real time protocol (“RTP”), real time control protocol, real time streaming protocol, or any other suitable protocols may be used for transfer of streaming content, such as proprietary protocols like Real and Microsoft's Windows Media. Non-streaming content may be delivered using HTTP, custom protocols over either transport control protocol or user datagram protocol, among others. Service provider 20 and/or authentication management service 70 may keep track of consumers receiving content 25, and circumstances surrounding the transactions. The information may be used for billing purposes or for other purposes.

In accordance with various aspects of the present invention, FIG. 2 illustrates an architecture 200 for securing an interface between peer devices 50, 250 exchanging data over network 11, using authentication management service 270. Conceptually, network 11 is divided into two realms-realm1 212, and realm 2 214. Each realm 212, 214 has a key distribution center (“KDC”) associated therewith—as shown, KDC 213 is associated with realm1 212, and KDC 215 is associated with realm2 214. KDC 213 operates to implement the functionality of authentication management service 270 in realm1 212. KDC 215 operates to implement the functionality of authentication management service 270 in realm 214. For purposes of illustration, the functionality of authentication management service 270 is depicted in block 280. Functions 282, 284, 286 and 288 are analogous to functions 82, 84, 86, and 88 depicted in block 80 in FIG. 1. It will be understood, however, that authentication management service 70 and authentication management service 270 are generally implemented separately, and it will be further understood that authentication management service 270 may be implemented by both KDC 213 and KDC 215.

KDC 213 interacts with consumer devices in realm1 212, while KDC 215 interacts with consumer devices in realm2 214.

Consumer devices that talk to the KDC 213 or 215 typically do not include the gateway—instead these are other consumer devices in the corresponding realm that want to acquire content available on the gateway. Both gateways 50 and 250 provide interfaces between network 11 and one or more managed devices 220 and 240, respectively, and/or internal networks in each realm. Internal networks may be, for example, home networks, consumer VPNs, or others. Managed devices may include among other things, consumer appliances such as home- or office-based personal computer (“PC”) systems, receiving, recording, or playback devices like VCRs, TiVO®, stereo systems and personal computer/television (PC/TV) devices (which may stand alone, or be included in other devices, such as set-top boxes), and other types of wired or wireless devices, such as personal digital assistants, radiofrequency communication devices, and other consumer/processor-based appliances now known or later developed.

Like gateway 50, gateway 250 may be a home gateway. Suitable gateways 250 are commercially available from Motorola, including the Motorola MS-1000™, and the Motorola SBG-1000™.

Internal arrangements, architectures and principles of operation of gateway 250 are well-known, and include the same basic internal components (not shown) and arrangements thereof as gateway 50, including, a computer-readable storage medium, a processor, and computer programs (which may be implemented in software, firmware, hardware, or any combination thereof), operating to implement an interface between managed devices 220 and 240 and network 11, and operating to implement functions of gateway 250. Gateway 250 may also have consumer characteristics 252 associated therewith, which, like the consumer characteristics associated with consumer/gateway 50, may include configuration data (not shown), which represents user—and system-defined configuration settings, such as communication settings, network settings, and the like, stored, for example, in a database (not shown). Examples of consumer characteristics include device characteristics, such as realm name, the fully qualified domain name (“FQDN”) or IP address of the gateway and the gateway's principal name; and include configuration data, such as the FQDN or IP address of the content provider's key distribution center (discussed further below), the realm of the content provider, or the FQDN or IP address of the content servers from which the gateway can retrieve selected content. Block 260 illustrates certain aspects of the functional arrangements of consumer 250 that relate to peer-to-peer access by consumer 250 to data in the possession of consumer 50, such as content 25.

Network/communication interface function 262, which may support, for example, a modem or other network connection support device(s) or program(s), is responsive to, and responsible for, mechanics of communication between IPRM Application 264 (discussed further below), IPRM Application 34 via network 11, and may be selected or implemented by one skilled in the art.

IPRM application 264 represents the client component, or agent, of a computer program, which, when executed, is capable of implementing one or more aspects of the process of delivering content 25 from consumer 50 to consumer 250 via network 11, in a peer-to-peer manner. IPRM application 264 may be a computer program stored in a computer-readable memory, but may also be hardware, software, firmware or any combination thereof. In addition, IPRM application 264 may operate as a client or a server component, as more fully described in U.S. Patent Application Publication No. 2003/0093694. IPRM application 264 may support, for example, composition, transmission, encryption, encoding, and compression of outbound communications and reception, decompression, decoding, decryption and presentation of inbound communications for a given type of media.

IPRM application 264 is preferably adapted to communicate with, via network/communication interface function 262, KDC 215. Both client and server components and functions of IPRM Application 264 may be implemented according to well-known software engineering practices for component-based software development.

As discussed in connection with FIG. 1, IPRM application 64, associated with consumer 50, is also adapted to communicate with, via network/communication interface function 62, KDC 213.

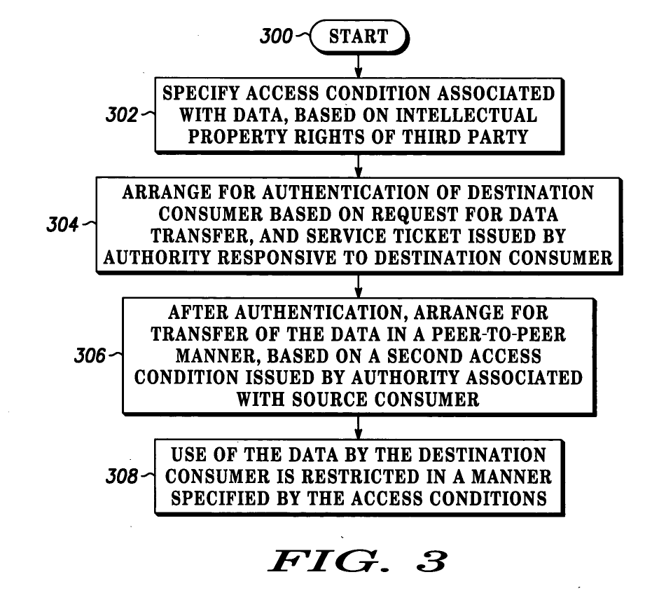

With continued reference to FIG. 2, FIG. 3 is a flowchart of a method, in accordance with one aspect of the present invention, for distributing data, such as content 25, which originates from a third party (for example, content provider 20) and is protected by intellectual property rights of the third party, in a peer-to-peer manner within network 11. The data is distributed between a source consumer, such as consumer 50 with devices that obtain authorization from a first authority, for example, KDC 213, and a destination consumer, such as consumer 250 with devices that obtain authorization from a second authority, for example, KDC 215. It should be noted that consumers 50 and 250 are gateways in the examples set forth herein, but need not be gateways, although it may be desirable to restrict sharing/copying of data to certain devices such as gateways.

The method begins at block 300, and continues at block 302, where an access condition associated with the data is specified. The access condition is based on the intellectual property rights of the third party, and may be further based on characteristics of the destination consumer's device (for example, gateway 250). Examples of gateway characteristics include, but are not limited to: a realm name, the FQDN or IP address of the gateway, a gateway' principal name, and the gateway's FQDN or IP address. The access condition may be based on a content license, which specifies permitted uses, and restrictions thereon, of the data.

At block 304, authentication of the destination gateway is arranged for based on a request for transfer of the data from the source consumer to the destination consumer, and based on a first service ticket issued by an authority responsive to the destination consumer. By way of example, one of the steps leading to authentication of the destination gateway 250 may be exchange of a cross-realm key. To allow for cross-realm ticket requests, an access control list in realm1 212 may already list realm2 214, but if not, a user of realm 212 may manually add the name of realm2 214 to its access control list (note that this ACL may, for convenience, be the same ACL that was used by consumer 50 when selecting the options for receiving content 50 from content provider 20—for example, content provider 20 may present a list of realm names or device IDs to consumer 50 to pick from at the time of creation of the content license). In another alternative, an administrator may be prompted with an input screen asking for approval/disapproval of adding realm2 214 to realm1 212's ACL.

One way of obtaining a cross-realm key is for consumer 250 to request a TGT for realm1 212, via an AS_REQ message directed to KDC 215. The AS_REQ message may include the fully-qualified domain name (FQDN) of KDC 213, to let KDC 215 know how to reach KDC 213. The FQDN may be obtained from a manually-administered configuration file, or from an out-of-band protocol.

Or, as will be appreciated, consumer gateway 250 may have previously requested a TGT for realm1 212, and as such, the TGT may be cached, and the cached TGT retrieved.

An alternative way to obtain the cross-realm key, which may be convenient if KDC 213 and consumer 50 are located on the same host (but could still be accomplished via an additional interface between KDC 213 and consumer 50), is to examine the content licenses currently present and associated with consumer 50, and if there is at least one content license that includes realm2 214, then permission may be granted to establish a shared cross-realm key.

To obtain the cross-realm key, KDC 215 may send a Service Key Req message to KDC 213 to obtain the cross-realm key, and KDC 213 may create, save and return the cross-realm key to KDC 215 via a Service Key Reply message. Then, in response to the AS_REQ message, consumer 250 would receive an AS_REP message from KDC 215, which includes the cross-realm TGT/key. It will be appreciated that gateways 50 and 250, and KDCs 213 and 215, respectively, may be implemented together, for example, a single application running on a single host in a user's home network, in which case intra-realm messaging between gateways and KDCs would not be necessary.

Alternatively, a Service Key Request and Service Key Reply exchange could be automatically triggered in the middle of the AS_REQ and AS_REP exchange. Such an automatic triggering of messages, however, would present the challenge of coordinating the back-off and re-try algorithms for both message exchanges.

In a further alternative, it is possible to establish the cross-realm key manually, to avoid implementing the additional messaging, although to maintain secure copy protection, the cross-realm key should still be hidden from the user. One way to securely share a cross-realm key would be for KDC 213 to generate the key locally, then export it into a file that is encrypted with KDC 215's public key. This file would be installable only on KDC 215 with the corresponding private key. The user of realm1 212 should not have access to KDC 213's private key and thus would not be able to decrypt the file and steal the cross-realm key, and no one except KDC 215 should be able to decrypt and utilize the cross-realm key.

In a still further alternative, the use of cross-realm keys may be avoided altogether (it should be noted that the following example assumes, for purposes of simplification, that source and destination devices and KDCs in their respective realms are implemented together, rendering intra-realm messaging between consumers and KDCs unnecessary). During an initial registration with a domain using the INIT_PRINC_REQ message, a consumer device in one realm, for example, consumer gateway 250 in realm2 214, may send its device certificate to a certification authority to obtain a new certificate with the realm name therein (note that, in general, initial device registration does not need to involve a certification authority if the device possesses a certificate that includes its realm name). The certification authority would issue another certificate to the gateway that includes the realm name, and return it via the INIT_PRINC_REPLY message. The realm name may then be added to the ACL of the remote/destination realm (for example, realm1 212), as described above. Consumer 250 may then request, via an AS_REQ message, a service ticket directly for consumer gateway 50 in realm1 212, or TGT from KDC 213 in realm1 212. The AS_REQ message could be authenticated using a digital certificate that proves consumer 250 in realm2 214, and KDC 213 is able to verify authorization for realm2 214 using an ACL or another alternative as set forth above. An AS_REP message to consumer 250 would include either a TGT for realm1 212, or a service ticket for consumer gateway 50. Although the TGT would be for a remote realm, it is encrypted using the regular TGS key for realm1 212, instead of a shared cross-realm key.

Assuming a TGT has been obtained by either use of a cross-realm key or a regular TGS key, then consumer 250 may use the TGT to communicate directly with KDC 213, and to request from it, via a TGS_REQ message, an ST that can be used to authenticate directly to consumer gateway 50. The TGS_REQ message may include therein the principal name of consumer gateway 50, obtained by consumer gateway 250 using a manually administered configuration file, or an out-of-band protocol. As will be appreciated, consumer gateway 250 may have previously cached this ticket. KDC 213, using a TGS_REP message, returns to consumer gateway 250 an ST for accessing consumer gateway 50.

After authentication of the destination consumer gateway, at block 306, peer-to-peer transfer of the data is arranged for, based on a second access condition issued by an authority responsive to the source consumer (for example, KDC 213).

In the example of transfer of content 25 between consumer 50 and consumer 250, one step leading to peer-to-peer transfer of data between the consumers may include consumer 250 sending a KEY_REQ message to consumer 50, authenticated by the ST obtained in the TGS_REP message. The KEY_REQ message may also include a DOI object (for example, a persistent rights request), that identifies the data and specifies if consumer 250 wishes to make copies of and/or share the data, and may include the FQDN or IP address of consumer gateway 50, obtained by consumer 250 using a manually administered configuration file, or an out-of-band protocol. A standard protocol could be used by consumer 250 to query the configuration parameters of consumer 50—the configuration parameters needed to access the data could be defined using session description protocol (“SDP”), which may be carried inside either HTTP or RTSP. Extended SDP attributes could be defined for this purpose. Other information, such as a content identifier (for example, a URI) may also appear as part of this configuration data. It will be appreciated that generally, for each consumer in another realm from whom content may be obtained, a configuration file entry having the following information may be obtained: the realm name, the FQDN or IP address of the KDC of the remote realm, the remote consumer's principal name, and the remote consumer gateway's FQDN or IP address (if different from the KDC's FQDN or IP address).

In response to receiving the KEY_REQ message from consumer 250, consumer 50 may return a KEY_REP message that includes the decryption key and the access condition. The access condition is based on the content license. If the content license, for example, indicates that the content may be shared with any device in realm2 214, then the “deviceBound” attribute of the Persistent Content Entitlements field of the DOI must not be set to “N”. In another example, if the content license indicates that the content may only be shared with consumer 250, but not any other device in realm2 214, then the “deviceBound” attribute must instead be set to “Y”. Care must be taken to include applicable rules in the Key Reply, for example, distinguishing between Copy Protection Rules, which deal with restrictions on content forwarding, and Persistent Content Entitlements, which deal with restrictions on copying. In a further example, when the KEY_REQ from consumer 250 indicates a particular number of playback times, such number must be reconciled with the permitted number of playbacks in the original content license, and should reduce the available playbacks permitted by consumer 50.

As depicted in block 308, use of the data by the destination consumer is restricted in a manner specified by the access conditions. Consumer 250 may, for example, based on the received access conditions, create a file to administer the access conditions, such as a content license file, which would restrict use of the data by consumer 250 in a manner specified by the access conditions. The content data may be received using an on-line streaming session or a file transfer protocol, or on a removable media, such as a CD or DVD or other storage medium, that can be later accessed by consumer 250 using the content license file.

Thus, a solution is provided for providing peer-to-peer transfer of content by intellectual property rights of third parties, while continuing to maintain control over unauthorized access to the content. The protocols described herein provide scalability needed in many environments, such as content streaming in a network where the content license allows the content to be shared under certain circumstances. The apparatuses and methods described herein may be applied, for example, to content that may be copied to any user's domain but also contains certain advertisements that a content provider wants recipients to receive. By keeping the content protected, it may be more difficult for users to bypass or remove the advertisements. In another example, the apparatuses and methods herein could provide scalability and protection for intellectual property rights in large peer-to-peer content sharing networks such as a secure and legitimate version of KaZaA.

Aspects of the present invention have been described as being implemented using a client-server, or peer-to-peer, architecture. It will be appreciated, however, that aspects of the present invention are not limited to any specific embodiments of computer programs or signal processing methods. For example, one or more processors packaged together or with other elements of architecture 200 may implement functions set forth herein in a variety of ways. In one example, both client and server components may be associated with the same computer system. In another example, server-server, or client-client operations may occur. It will also be appreciated that computer programs referred to herein may be any stored instructions, in one or more parts (stored, for example, on storage media referred to herein, or on other internal or external storage medium such as a read-only-memory or a random-access memory), and may include firmware or hardware, and may be used or implemented by one or more elements, including one or more processors, to implement functions provided by architecture 200.

Moreover, although specific functional elements and arrangements thereof have been described herein, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled. Connections depicted herein may be logical or physical in practice to achieve a coupling or communicative interface between elements. Connections may be implemented as inter-process communications among software processes.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method (300) for distributing data (25), within a network (11), between a source consumer (50) and a destination consumer (250), the data originating from, and protected by predetermined intellectual property rights of, a third party (20), the method comprising:
specifying (302) a first access condition associated with the data, the access condition based on the predetermined intellectual property rights;
based on a request requesting transfer of the data from the source consumer to the destination consumer, and based on a service ticket issued by an authority associated with the source consumer, arranging (304) for authentication of the destination consumer; and
after authentication of the destination consumer, based on a second access condition issued by an authority associated with the source consumer, arranging (306) for transfer of the data, via the network in a peer-to-peer manner, from the source consumer to the destination consumer,
use (308) of the data by the destination consumer restricted in a manner specified by the first and second access conditions.

2. The method according to claim 1, wherein the first access condition is further based on consumer characteristics (252) associated with the destination consumer.

3. The method according to claim 2, wherein the consumer characteristics (252) comprise one of a destination consumer domain name, or destination consumer device identity.

4. The method according to claim 1, further comprising the steps of:
based on the service ticket, authenticating the destination consumer; and
based on the first and second access conditions, transferring the data via the network in a peer-to-peer manner, from the source consumer to the destination consumer.

5. The method according to claim 1, further comprising:
arranging for creation of a content license by the destination consumer based on the first and second access conditions.

6. The method according to claim 5, wherein the use of the data by the destination consumer is restricted in a manner specified in the content license.

7. The method according to claim 1, wherein the network comprises the Internet.

8. The method according to claim 7, wherein the destination consumer comprises a set-top box.

9. The method according to claim 1, wherein the step of arranging for authentication of the destination consumer comprises arranging for authentication of a gateway device (250) associated with the destination consumer.

10. The method according to claim 1, further comprising:
prior to arranging for transfer of the data, encrypting the data.

11. The method according to claim 10, wherein the step of encrypting comprises forming ciphertext based on the data and an encryption key, according to a predetermined encryption routine.

12. The method according to claim 10, further comprising:
authenticating the data, after the data has been transferred.

13. The method according to claim 1, wherein the access condition is based on a content license from a provider of the data.

14. The method according to claim 13, wherein the content license is located at the source consumer.

15. The method according to claim 1, wherein the service ticket had been obtained with a ticket granting server request/reply exchange between the destination consumer and a key distribution center associated with the source consumer, and authenticated using a ticket granting ticket encrypted with a cross-realm key.

16. The method according to claim 15, wherein the step of arranging for authentication of the destination consumer comprises establishing security associations between the key distribution center associated with the source consumer and a key distribution center associated with the destination consumer, using the shared cross-realm key.

17. The method according to claim 1, wherein the service ticket is obtained based on an authentication server AS request/reply exchange between the destination consumer and a key distribution center associated with the source consumer, and
wherein the destination consumer is authenticated with a digital authentication certificate associated with the destination consumer, the digital authentication certificate including a realm name of the destination consumer.

18. The method according to claim 1, wherein the step of arranging for transfer of the data comprises arranging for one of streaming, moving and copying of the data.

19. A computer-readable medium encoded with a computer program which, when loaded into a processor, implements the method of claim 1.

20. A system for distributing data (25), within a network (11), between a source consumer (50) responsive to a first key distribution center (213) and a destination consumer (250) responsive to a second key distribution center (215), the data (25) originating from, and protected by predetermined intellectual property rights of, a third party (20), the system comprising:
a network communications interface (62/262/282) for receiving a request for transfer of the data (25) from the source consumer (50) to the destination consumer (250), and for transferring the data (25) from the source consumer (50) to the destination consumer (250), via the network (11), in a peer-to-peer manner in response to the request; and
an information processing system (64/264/284) in communication with the network communications interface, for processing the request received by the source network communications interface, and, based on the request, performing a method comprising:
arranging for authentication of the destination consumer based on a service ticket issued by the first key distribution center;
arranging for determining whether the destination consumer is authorized, in a manner specified by a first access condition based on the predetermined intellectual property rights of the third party, to receive the data from the source consumer; and
based on a second access condition returned by the source consumer, arranging for transfer, via the network communications interface, of the data from the source consumer to the destination consumer,
use of the data by the destination consumer restricted in a manner specified by the first and second access conditions.

21. The system according to claim 20, wherein the network communications interface (62, 262) is associated with a gateway device (50/250) of one of the source consumer and the destination consumer.

22. The system according to claim 21, wherein the information processing system comprises a processor (54) responsive to a computer-readable storage medium (52) and to a computer program (56), the computer program, when loaded into the processor, operative to perform the method.

23. The system according to claim 22, wherein the processor is associated with the gateway device.

24. The system according to claim 20, wherein the network communications interface (282) is associated with a server (270) accessible to the source consumer via the network.

25. The system according to claim 24, wherein the information processing system comprises a processor (24) responsive to a computer-readable storage medium (22) and to a computer program (26), the computer program, when loaded into the processor, operative to perform the method.

26. The system according to claim 25, wherein the processor is associated with the server (270).
